(19) United States
(12) Patent Application Publication
(10) Pub. No.: US 2016/0081471 A1
(43) Pub. Date: Mar. 24, 2016

(54) SUPPORTING STRUCTURE AND LOADING-TRANSPORTING METHOD OF STORAGE AND TRANSPORT CONTAINER

(71) Applicants: NANTONG CIMC TANK EQUIPMENT CO., LTD., Jiangsu (CN); CHINA INTERNATIONAL MARINE CONTAINERS (GROUP) LTD., Guangdong (CN); CIMC ENRIC INVESTMENT HOLDINGS (SHENZHEN) CO., LTD., Guangdong (CN)

(72) Inventors: Yuliang QIAN, Jiangsu (CN); Huanghe QUAN, Jiangsu (CN)

(21) Appl. No.: 14/890,264

(22) PCT Filed: Jul. 17, 2013
(86) PCT No.: PCT/CN2013/079542

§ 371 Date: Nov. 10, 2015

(30) Foreign Application Priority Data
May 14, 2013 (CN) 201310178991.8

(51) Int. Cl. A47B 81/00; B65G 65/00; A47F 7/28

(52) U.S. Cl. CPC A47B 81/007; A47F 7/28; B65G 65/00

(57) ABSTRACT

A supporting structure (10) and a loading-transporting method of a storage and transport container, and the supporting structure (10) comprises a base frame (13), a first frame support (11) and a second frame support (12) both disposed on the base frame (13). The first frame support (11) comprises at least two groups of first supporting beams (111) and first arc-shaped supporting plates (112) disposed on each group of first supporting beams (111). The groups of first supporting beams (111) are parallel and spaced with each other, and each group of first supporting beams (111) comprises at least two first transverse supporting beams (111a, 111b). Each first arc-shaped supporting plate (112) is connected to at least two first transverse supporting beams (111a, 111b) in the same group. The second frame support (12) comprises at least two groups of second supporting beams (121) and second arc-shaped supporting plates (122) disposed on each group of second supporting beams (121). The groups of second supporting beams (121) are parallel and spaced with each other, and each group of second supporting beams (121) comprises at least two second transverse supporting beams (121a) arranged in a transverse direction. Each second arc-shaped supporting plate (122) is connected to at least two second transverse supporting beams (121a) in the same group. The first frame support (11) is higher than the second frame support (12). The supporting structure (10) and the loading-transporting method of the storage and transport container reduce the transportation cost.

### TECHNICAL FIELD

The disclosure relates to the field of container, and specifically to a supporting structure of a storage and transport container for achieving containerization transportation and a loading-transporting method of the storage and transport container.

### BACKGROUND

Nuclear fuel, such as uranium hexafluoride, is generally stored in a specific steel bottle vessel due to its radioactivity. As containerization transportation is becoming increasingly mature and due to its advantages on the transportation, frame boxes or traditional boxes are generally adopted for containerization transportation of storage and transport container of nuclear fuel to increase freight capacity, reduce freight charge and facilitate integration of sea and land transport. However, due to space limit of the traditional boxes, a single box can only load and transport three steel bottle vessels of uranic fluoride, causing lower space utilization. With respect to the frame box, a single box is capable of loading and transporting six steel bottle vessels of 48-series uranium hexafluoride, however it takes more than three times of transportation cost due to its specialty compared to traditional boxes.

Therefore, in order to reduce the transportation cost of steel bottle vessels of uranium hexafluoride, it's urgent to develop a new transportation structure and method of fuel vessels to overcome the above disadvantages known in the art.

### SUMMARY

Considering the above problems, the present disclosure proposes a supporting structure of the storage and transport container, which facilitate containerization transportation, and can solve problems of high transportation cost of storage and transport container of nuclear fuel, and problems of obstructing products circulation and transportation.

In order to solve the above problems, the present disclosure proposes a supporting structure of the storage and transport container for achieving containerization transportation. The supporting structure comprises a base frame, a first frame support and a second frame support disposed on the base frame. The first frame support comprises at least two groups of first supporting beams arranged in a longitudinal direction and first arc-shaped supporting plates disposed on each group of first supporting beams. The groups of first supporting beams are parallel and spaced with each other, and each group of first supporting beams comprises at least two first transverse supporting beams. Each first arc-shaped supporting plate is connected to at least two first transverse supporting beams in the same group. The second frame support comprises at least two groups of second supporting beams arranged in a longitudinal direction and second arc-shaped supporting plates disposed on each group of second supporting beams. The groups of second supporting beams are parallel and spaced with each other, and each group of second supporting beams comprises at least two second transverse supporting beams arranged in a transverse direction. Each second arc-shaped supporting plate is connected to at least two second transverse supporting beams in the same group. The first frame support is higher than the second frame support.

With respect to the supporting structure of the storage and transport container, wherein a height in a transverse direction of at least two first transverse supporting beams located in the same group is gradually decreased from outside to inside of the supporting structure, and a height in a transverse direction of at least two second transverse supporting beams located in the same group is gradually decreased from outside to inside of the supporting structure.

With respect to the supporting structure of the storage and transport container, wherein the first frame support further comprises a transverse straining beam connecting two adjacent first transverse supporting beams.

With respect to the supporting structure of the storage and transport container, wherein the first frame support further comprises an inclined straining beam connecting two adjacent first transverse supporting beams and forming an oblique angle with the two adjacent transverse supporting beams.

With respect to the supporting structure of the storage and transport container, wherein the first frame support further comprises a stiffening beam connecting the first supporting beams in different groups.

With respect to the supporting structure of the storage and transport container, wherein the first frame support and the second frame support are arranged on both sides of a longitudinal center line of the base frame.

With respect to the supporting structure of the storage and transport container, wherein the base frame comprises a plurality of bottom longitudinal beams extending along the longitudinal direction and a plurality of bottom transverse beams extending along the transverse direction. The bottom longitudinal beams are perpendicularly cross-connected with the bottom transverse beams. Fork pockets are formed between two adjacent bottom longitudinal beams to fit with prongs of a forklift.

With respect to the supporting structure of the storage and transport container, wherein an arc-shaped sliding plate is disposed at one end of the bottom longitudinal beam to fit with the forklift.

The disclosure also provides a loading-transporting method of the storage and transport container, comprising the following steps:
S1: providing a supporting structure of the storage and transport container as above;
S2: positioning one storage and transport container on the first arc-shaped supporting plate, while positioning another on the second arc-shaped supporting plate, wherein the two storage and transport containers are stagger-positioned, allowing stiffening rings of the two storage and transport containers spaced in a front and back direction, and allowing lifting lugs of the two storage and transport containers obliquely spaced with each other;
S3: binding the two storage and transport containers with a tightening means and then securing them on the supporting structure;
S4: putting the supporting structure and the storage and transport containers secured on the supporting structure into a container by the forklift.

With respect to the loading-transporting method of the storage and transport container, wherein the container is a traditional box with 40 feet, three groups of the supporting structure are positioned in the container, and the adjacent two groups of the first frame support and the second frame support are stagger-positioned.

In the present disclosure, the storage and transport container is supported by disposing the supporting structure, and location of the supporting structure is reasonably arranged in the container, allowing a single 40-foot traditional box is capable of loading 6 storage and transport containers, which improves loading capacity of the container and reduces transportation cost.

In addition, the present supporting structure facilitates assembly and disassembly, can applicable to a large variety of assembly and disassembly tools, and greatly improves efficiency of assembly and disassembly.

In addition, the cooperating-use of the tightening means ensures safety during the transportation process.

### BRIEF DESCRIPTION OF THE DRAWINGS

FIG. 1 is a stereoscopic structural schematic view of the supporting structure of the storage and transport container according to the present disclosure.

FIG. 2 is a front-side schematic view of FIG. 1.

FIG. 3 is a left-side schematic view of FIG. 1.

FIG. 4 is a flow chart of the loading-transporting method of the storage and transport container according to the present disclosure.

FIG. 5 is a structural schematic view when the storage and transport container is supported by the supporting structure according to the present disclosure.

FIG. 6 is a structural schematic view when the supporting structure and the storage and transport container are loaded into the container according to the present disclosure.

### DETAILED DESCRIPTION OF THE DISCLOSURE

In order to further explain the principle and structure of the present disclosure, the preferred embodiments of the present disclosure will be illustrated in detail in combination with the accompanying drawings.

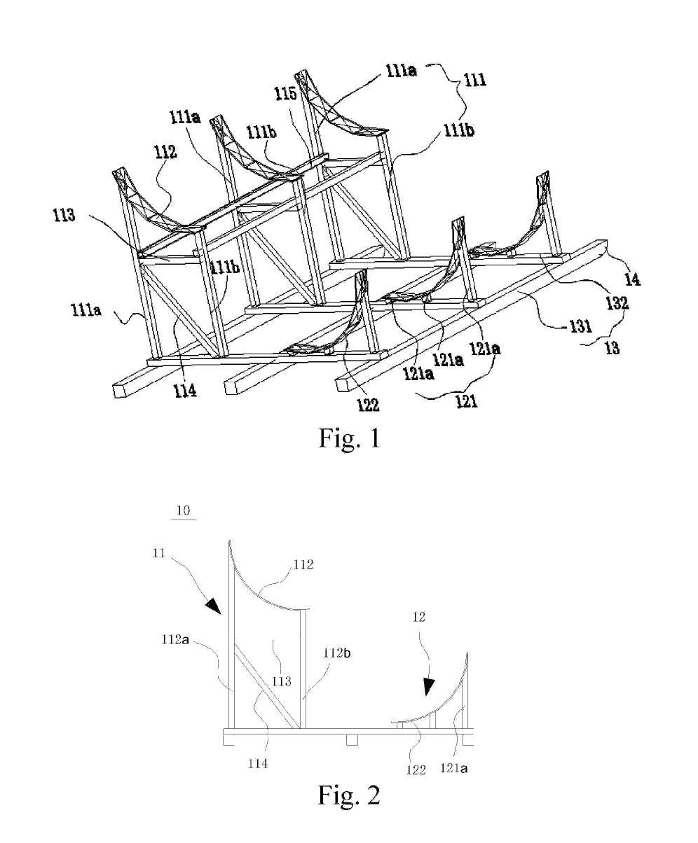

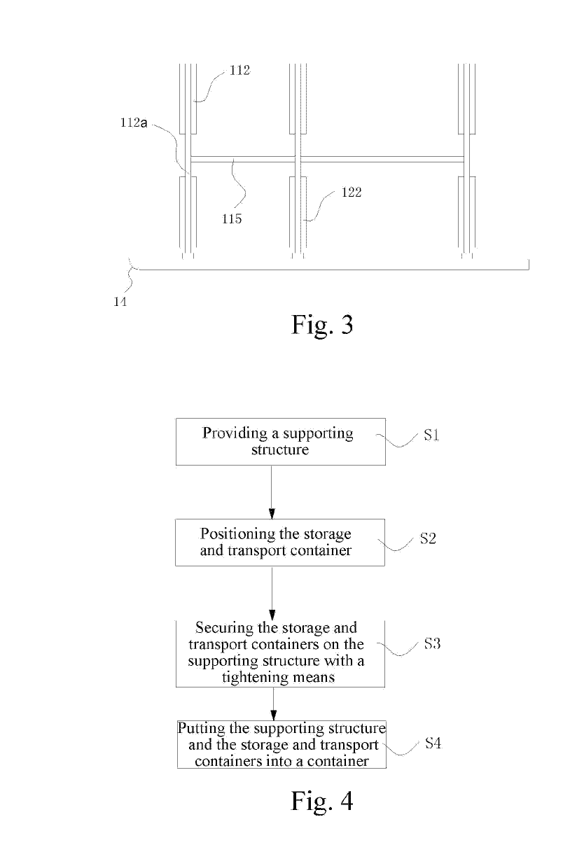

As shown in FIGS. 1-3, the supporting structure 10 of the storage and transport container of the present disclosure for achieving containerization transportation comprises a base frame 13, a first frame support 11 and a second frame support 12 disposed on the base frame 13.

The base frame 13 comprises a plurality of bottom longitudinal beams 131 extending along the longitudinal direction and a plurality of bottom transverse beams 132 extending along the transverse direction. The bottom longitudinal beams 131 are perpendicularly cross-connected with the bottom transverse beams 132. Fork pockets are formed between two adjacent bottom longitudinal beams 131 to fit with prongs of a forklift. Moreover, an arc-shaped plate 14 is disposed at one end of the bottom longitudinal beam 131 to fit with the forklift and is used for reducing frictional force caused during the pulling and pushing by the forklift. The first frame support 11 comprises three groups of first supporting beams 111 secured on the bottom transverse beams 132 and arranged in a longitudinal direction, the groups of first supporting beams 111 are parallel and spaced with each other. Each group of first supporting beams 111 comprises a first transverse supporting beam 111a, a first transverse supporting beam 111b arranged in a transverse direction, and the height of the first transverse supporting beam 111a is higher than that of the first transverse supporting beam 111b. An arc-shaped supporting plate 112 for carrying the storage and transport container is disposed correspondingly on each group of the first supporting beams 111, and the first arc-shaped supporting plates 112 in different groups are parallel with each other and have the same height. The arc-shaped supporting plate 112 connects two first transverse supporting beams 111a, 111b in the same group and is secured on the top end of the first transverse supporting beams 111a, 111b, forming arc-shaped supporting surface with a higher left and a lower right.

In addition, in order to reinforce supporting intensity of the supporting structure 10 and enhance its stability, a transverse straining beam 113 is preferably disposed between two adjacent first transverse supporting beams (i.e. between the first transverse supporting beam 111a and the first transverse supporting beam 111b) in the same group.

In addition, in order to further reinforce supporting intensity of the supporting structure 10 and enhance its stability, an inclined straining beam 114 is preferably disposed between two adjacent first transverse supporting beams (i.e. between the first transverse supporting beam 111a and the first transverse supporting beam 111b) in the same group. The inclined straining beam 114 is located under the transverse straining beam 113, its two ends are respectively secured on the first transverse supporting beams 111a and 111b, and form an inclined angle with the first transverse supporting beams 111a and 111b. The top end of the inclined straining beam 114 is welded at the right angle formed between the transverse straining beam 113 and the first transverse supporting beam 111a, while the lower end is welded at the right angle formed between the bottom transverse beam 132 and the first transverse supporting beam 111b. Of course, it is not limited to the above embodiments. The top end of the inclined straining beam 114 may be welded at the right angle formed between the transverse straining beam 113 and the first transverse supporting beam 111b, while the lower end may be welded at the right angle formed between the bottom transverse beam 132 and the first transverse supporting beam 111a.

In addition, in order to reinforce connection between the first transverse supporting beams 111 in different groups, a stiffening beam 115 is preferably disposed between the first transverse supporting beams 111a (or between the first transverse supporting beams 111b) in different groups to allow the first supporting beams 111 in different groups to be integrated together.

The second frame support 12 comprises three groups of the second supporting beams 121 arranged in a longitudinal direction, and the second arc-shaped supporting plates 122 correspondingly disposed on each group of the second supporting beams 121 for carrying the storage and transport container. The groups of the second supporting beams 121 are parallel and spaced with each other, and disposed on the different bottom transverse beams 132. Each group of the second supporting beams 121 comprises a plurality of the second transverse supporting beams 121a arranged in a transverse direction, the plurality of the transverse supporting beams 121a are parallel with each other and have different heights, the heights is gradually decreased from outside to inside of the supporting structure 10 in a transverse direction. The second arc-shaped supporting plate 122 is connected with a plurality of second transverse supporting beams 121a and secured on the top end of these second transverse supporting beams 121a, forming arc-shaped supporting surface with a higher left and a lower right. The second arc-shaped supporting beams 122 in different groups are parallel with each other and have the same height.

As shown in FIG. 1, the first frame support 11 and the second frame support 12 are arranged on both sides of a longitudinal center line (i.e. an extending direction along the middle bottom longitudinal beam of FIG. 1) of the base frame 13 respectively, and the first supporting beam 111 and the second supporting beam 121 in the same group of are secured on the same bottom transverse beam 132. The first frame support 11 is higher than the second frame support 12, allowing the first arc-shaped supporting plate 112 being higher than the second arc-shaped supporting plate 122 to allow center of the storage and transport container disposed on the first arc-shaped supporting plate 112 departing from that of the storage and transport container disposed on the second arc-shaped supporting plate 122. Both of them are stagger-disposed to maximize loading capability of the supporting structure.

The disclosure also provides a method for achieving containerization transportation utilizing the above supporting structure to load and transport the storage and transport container. The loading-transporting method of storage and transport container is illustrated in detail below, combined with FIG. 4.

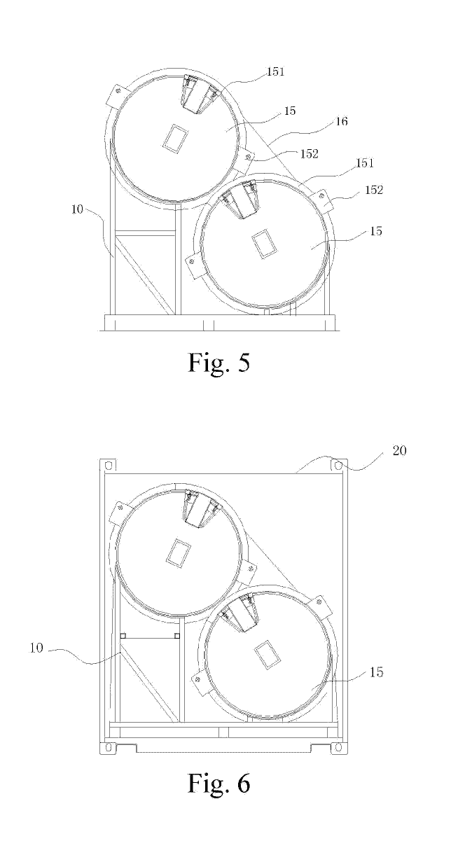

The loading-transporting method of the storage and transport container comprises the following steps:
S1: providing a supporting structure as above;
S2: as shown in FIG. 5, positioning one storage and transport container 15 on the first arc-shaped supporting plate of the supporting structure 10, while positioning another on the second arc-shaped supporting plate of the supporting structure 10, wherein the two storage and transport containers 15 are stagger-positioned, allowing stiffening rings 151 of the two storage and transport containers 15 also staggered in a front and back direction, and lifting lugs 152 of the two storage and transport containers obliquely staggered, so as to avoid mutual interference between stiffening rings 151 and lifting lugs 152 and space occupation;
S3: binding the two storage and transport containers 15 with a tightening means 16 and then securing them on the supporting structure 10, wherein the tightening means 16 may be a tightening belt;
S4: putting the supporting structure 10 assembled according to the steps S1 to S3 and the storage and transport containers 15 into an internal specified position of a container 20 by the forklift, as shown in FIG. 6.

In addition, when the supporting structure 10 is lifted by the forklift, it should be noted that: prongs of the forklift should be departed from the length center of the storage and transport container 15, and close to one end of the sliding plate of the bottom longitudinal beam, allowing the barycenter of the storage and transport containers 20 on the supporting structure 10 situated on the prongs to prevent from cocking and overturning of one end during fork-lifting process of the forklift, so as to allow the forklift lifting the supporting structure 10 successfully.

The container 20 in this embodiment is a traditional box with 40 feet, three groups of the supporting structure 10 may be positioned in a single container 20 in a length direction. When the supporting structure 10 is loaded into the container 20, the adjacent two groups of the first frame supports and the second frame supports of the supporting structure 10 are staggered, i.e. the adjacent two groups of the supporting structure 10 are alternate in the left and right position, that is to say, if the preceding group is stacked in a stacking mode of higher left and lower right, the subsequent group should be stacked in a stacking mode of lower left and higher right, so as to avoid the barycenter tilting to one side during tilting of the container 20.

Above all, in the present disclosure, a single traditional box with 40 feet may be capable of loading 6 storage and transport containers (e.g. 48-series vessel of uranium hexafluoride (UF6)) by disposing the supporting structure with different heights of right and left to support the storage and transport containers, and by reasonably arranging positions of the supporting structure in the container. This improves loading capability of the container and reduces transportation cost. Moreover, the cooperating-use of the tightening means ensures safety during the transportation process. In addition, the present supporting structure facilitates assembly and disassembly, has broad applicability for assembly and disassembly tools, and greatly improves efficiency of assembly and disassembly.

In addition, the storage and transport container of the present disclosure may comprise steel bottle vessel for loading and transporting nuclear fuel, or other vessels with similar shapes.

Moreover, in the above embodiment, the base frame comprises three bottom longitudinal beams, however it is not limited the above embodiments. The bottom longitudinal beam may be four or more.

In addition, in the above embodiment, the first frame support comprises three groups of the first supporting beams, however it is not limited the above embodiments. Two, four or more groups of the first supporting beams may be disposed on the first frame support in a longitudinal direction. Similarly, the first arc-shaped supporting plate disposed on the first supporting beam is changed as the number of the first supporting beams.

In addition, in the above embodiment, the first supporting beams in the same group comprise two first transverse supporting beams, however it is not limited to this embodiment. The first supporting beams in the same group may comprise more than two first transverse supporting beams, wherein the heights of first transverse supporting beams are unequal, the heights is gradually decreased from outside to inside of the supporting structure in a transverse direction.

In addition, in the above embodiment, the second frame support comprises three groups of the second supporting beams, however it is not limited to this embodiment. Two, four or more groups of the first supporting beams may be disposed on the first frame support in a longitudinal direction. Similarly, the first arc-shaped supporting plate disposed on the second supporting beam is changed as the number of the second supporting beam.

The above embodiments are only the preferred embodiments of the present disclosure, and do not limit the protection scope of the present disclosure. Any conversions, or direct or indirect utilities into other relative technical fields, using equivalent structure or procedure made by the description and accompanying drawings of the present disclosure, are also included within the patent protection scope of the present disclosure.

What is claimed is:

1. A supporting structure of the storage and transport container for achieving containerization transportation, characterized in that, the supporting structure comprises a base frame, a first frame support and a second frame support disposed on the base frame, the first frame support comprising at least two groups of first supporting beams arranged in a longitudinal direction and first arc-shaped supporting plates disposed on each group of first supporting beams, the groups of first supporting beams being parallel and spaced with each other, and each group of first supporting beams comprising at least two first transverse supporting beams, each first arc-shaped supporting plate being connected to at least two first transverse supporting beams in the same group; the second frame support comprising at least two groups of second supporting beams arranged in a longitudinal direction and second arc-shaped supporting plates disposed on each group of second supporting beams, the groups of second supporting beams being parallel and spaced with each other, and each group of second supporting beams comprising at least two second transverse supporting beams arranged in a transverse direction, each second arc-shaped supporting plate being connected to at least two second transverse supporting beams in the same group; the first frame support is higher than the second frame support.

2. The supporting structure of the storage and transport container according to claim 1, characterized in that, a height in a transverse direction of the at least two first transverse supporting beams located in the same group is gradually decreased from outside to inside of the supporting structure, and a height in a transverse direction of the at least two second transverse supporting beams located in the same group is gradually decreased from outside to inside of the supporting structure.

3. The supporting structure of the storage and transport container according to claim 1, characterized in that, the first frame support further comprises a transverse straining beam connecting the two adjacent first transverse supporting beams.

4. The supporting structure of the storage and transport container according to claim 1, characterized in that, the first frame support further comprises an inclined straining beam connecting the two adjacent first transverse supporting beams and forming an oblique angle with the two adjacent transverse supporting beams.

5. The supporting structure of the storage and transport container according to claim 1, characterized in that, the first frame support further comprises a stiffening beam connecting the first supporting beams in different groups.

6. The supporting structure of the storage and transport container according to claim 1, characterized in that, the first frame support and the second frame support are arranged on both sides of a longitudinal center line of the base frame respectively.

7. The supporting structure of the storage and transport container according to claim 1, characterized in that, the base frame comprises a plurality of bottom longitudinal beams extending along the longitudinal direction and a plurality of bottom transverse beams extending along the transverse direction, the bottom longitudinal beams are perpendicularly cross-connected with the bottom transverse beams, fork pockets are formed between the two adjacent bottom longitudinal beams to fit with prongs of the forklift.

8. The supporting structure of the storage and transport container according to claim 7, characterized in that, an arc-shaped sliding plate is disposed at one end of the bottom longitudinal beam to fit with the forklift.

9. A loading-transporting method of the storage and transport container, characterized in that, the loading-transporting method comprises the following steps:
S1: providing a supporting structure of the storage and transport container according to any one of claims 1;
S2: positioning one storage and transport container on the first arc-shaped supporting plate, and positioning another on the second arc-shaped supporting plate, wherein these two storage and transport containers are stagger-positioned, allowing stiffening rings of the two storage and transport containers staggered in a front and back direction, and lifting lugs of the two storage and transport containers obliquely staggered with each other;
S3: binding the two storage and transport containers with a tightening means and then securing them on the supporting structure;
S4: putting the supporting structure and the two storage and transport containers secured on the supporting structure into a container by the forklift.

10. The loading-transporting method of the storage and transport container according to claim 9, characterized in that, the container is a traditional box with 40 feet, three groups of the supporting structure are positioned in the container, and the adjacent two groups of the first frame support and the second frame support are stagger-positioned.

11. The loading-transporting method of the storage and transport container according to claim 9, characterized in that, a height in a transverse direction of the at least two first transverse supporting beams located in the same group is gradually decreased from outside to inside of the supporting structure, and a height in a transverse direction of the at least two second transverse supporting beams located in the same group is gradually decreased from outside to inside of the supporting structure.

12. The loading-transporting method of the storage and transport container according to claim 9, characterized in that, the first frame support further comprises a transverse straining beam connecting the two adjacent first transverse supporting beams.

13. The loading-transporting method of the storage and transport container according to claim 9, characterized in that, the first frame support further comprises an inclined straining beam connecting the two adjacent first transverse supporting beams and forming an oblique angle with the two adjacent transverse supporting beams.

14. The loading-transporting method of the storage and transport container according to claim 9, characterized in that, the first frame support further comprises a stiffening beam connecting the first supporting beams in different groups.

15. The loading-transporting method of the storage and transport container according to claim 9, characterized in that, the first frame support and the second frame support are arranged on both sides of a longitudinal center line of the base frame respectively.

16. The loading-transporting method of the storage and transport container according to claim 9, characterized in that, the base frame comprises a plurality of bottom longitudinal beams extending along the longitudinal direction and a plurality of bottom transverse beams extending along the transverse direction, the bottom longitudinal beams are perpendicularly cross-connected with the bottom transverse beams, fork pockets are formed between the two adjacent bottom longitudinal beams to fit with prongs of the forklift.

17. The loading-transporting method of the storage and transport container according to claim 9, characterized in that, an arc-shaped sliding plate is disposed at one end of the bottom longitudinal beam to fit with the forklift.
